(19) United States
(12) Patent Application Publication
(10) Pub. No.: US 2007/0156255 A1
(43) Pub. Date: Jul. 5, 2007

(54) Selecting resources to perform physical operations

(76) Inventors: Holger Herrmann, Malsch (DE); Venkiteswaran V. B., Bangalore (IN); Pradeep Nair, Chermundassery (IN); Jan Richert, Mannheim (DE)

Correspondence Address: FISH & RICHARDSON, P.C., PO BOX 1022, MINNEAPOLIS, MN, 55440-1022, US

(21) Appl. No.: 11/321,256

(22) Filed: Dec. 29, 2005

(51) Int. Cl. G05B 11/01

(52) U.S. Cl. 700/17

(57) ABSTRACT

Resources to perform physical operations are selected upon receiving an electronic request. The physical operation is identified in the computer system as requiring use of a specific type of physical resource. The method includes determining whether at least one electronic resource object includes a physical characteristic attribute that meets a predefined requirement associated with performing the physical operation. The determination is made among at least one electronic resource object representing an individual physical resource having the specific type. A computer system includes a repository having stored therein the resource objects, and a resource management module configured to perform the determination.

### TECHNICAL FIELD

The description relates to selecting resources using a resource object having a physical characteristic attribute.

### BACKGROUND

There exists systems for computerized automation of operations and processes in industrial or other commercial enterprises. Examples of such existing systems are those available from SAP AG in Walldorf (Baden) Germany. Some of the existing systems are intended for use with the logistic procedures and operations that are common in manufacturing processes and they are therefore typically used in production plants. Other systems, or components of systems, are intended for use in the logistic management of products that have already been manufactured. They are therefore typically used in warehouses, distribution centers and other facilities where goods may be inspected, repacked and moved to particular storage locations while awaiting shipment.

The distribution of responsibilities and functionality between these two categories of systems is based on the way that these industries have emerged and developed historically. That is, over decades in the past, production plants and similar facilities have carried out their operations according to well-established routines that involve the basic steps of making the product. Improvements in technology have changed the way certain tasks are performed, but the general logistic view of how the core constituents of the manufacturing process is carried out has not changed as significantly. Similarly, warehouses have traditionally been viewed as facilities mainly for logistic management of goods without significant modification and, thus, essentially non-manufacturing in nature.

This view is reflected in the existing systems for controlling manufacturing processes. The computer model they use for the different components of the process are typically specialized and heavily flavored by the traditional manufacturing view. Systems for warehouse management, in contrast, have other computer models that are targeted toward managing the logistics of storing and eventually delivering goods. A disadvantage of existing systems, then, is that they are designed and configured for only their type of process and lack flexibility in adapting to new demands in the industry and the marketplace that challenge the traditional views.

Existing systems work with resources that are used in the different types of facilities. For example, the manufacturing industry uses drills, routers and other machines dedicated to making products. The warehouse field, in turn, uses trucks, forklifts, packing stations and other equipment in moving and packing the manufactured products. In each of the areas, employees may supervise the machinery, or operate it, to cause a particular physical operation to be performed. The employees are sometimes modeled as separate resources in the computer system that controls the operation.

Physical operations can sometimes be performed in more than one situation. For example, an operation can involve moving a product into a storage bin located in a warehouse aisle, or it can involve moving the product into a staging area to await loading on a truck. In moving the product into the storage bin, the resource must pass through the aisle and perhaps make a partial turn before unloading. This cannot be done if the resource is too big based on the size of the aisle and other physical characteristics. In contrast, the corresponding parameters that characterize the staging area may be less restrictive.

Existing systems may have disadvantages in the way resources are selected. For example, the data model used in resource management may not reflect resource characteristics, such as the width and lifting capacity of a forklift, such that they can be taken into account when evaluating a resource object. Rather, such limitations may be registered separately, which requires extra maintenance to keep them updated and which may make resource selection less efficient.

### SUMMARY

The invention relates to selecting a resource to perform a physical operation.

In a first general aspect, a method of selecting resources to perform physical operations includes receiving, in a computer system, an electronic request to initiate performance of a physical operation. The physical operation is identified in the computer system as requiring use of a specific type of physical resource. The method includes determining whether at least one electronic resource object includes a physical characteristic attribute that meets a predefined requirement associated with performing the physical operation. The determination is made among at least one electronic resource object representing an individual physical resource having the specific type.

Implementations may include any or all of the following features. When the electronic resource object has the physical characteristic attribute that meets the predefined requirement, the physical resource represented by the electronic resource object may be selected and performance of the physical operation initiated. Associated costs may be determined after the performance of the physical operation using the electronic resource object. The predefined requirement may be obtained from another resource object that is to be involved in performance of the physical operation. The predefined requirement may be obtained from a storage location that is to be involved in performance of the physical operation. When the computer system includes several electronic resource objects, at least one of the several electronic resource objects may correspond to a production plant resource and at least one of the several electronic resource objects may correspond to a warehouse resource. The several electronic resource objects may be configured so that the determination step can be performed for operations involving the production plant resource and for operations involving the warehouse resource. The physical characteristic attribute may be automatically updated based on a change in the physical resource.

In a second general aspect, a computer system includes a repository having stored therein resource objects corresponding to respective physical resources of particular types. The system is configured to use any of the resource objects in initiating performance of a physical operation using the corresponding physical resource. The system includes a resource management module configured to determine whether any of the resource objects that is of a specific type needed for a physical operation includes a physical characteristic attribute that meets a predefined requirement associated with performing the physical operation.

Implementations may include any or all of the following features. The resource management module may be configured to select the physical resource represented by the resource object upon determining that the resource object has the physical characteristic attribute that meets the predefined requirement and initiate performance of the physical operation. The system may further include a cost determination module configured to determine associated costs after the performance of the physical operation using the resource object. The resource management module may be configured to obtain the predefined requirement from another resource object that is to be involved in performance of the physical operation. The resource management module may be configured to obtain the predefined requirement from a storage location that is to be involved in performance of the physical operation. At least one of the several resource objects may correspond to a production plant resource and at least one of the several electronic resource objects may correspond to a warehouse resource. The several resource objects may be configured so that the resource management module can perform the determination for operations involving the production plant resource and for operations involving the warehouse resource. The resource management module may be configured to automatically update the physical characteristic attribute based on a change in the physical resource. The resource management module may be configured so that the physical characteristics attributes can be modified.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a computer system that automatically selects physical resources to perform physical operations;

FIG. 2 is a block diagram of a computer system that automatically selects physical resources to perform physical operations in either or both of a production plant and a warehouse;

FIG. 3 is a flow chart of exemplary operations relating to selecting a resource to perform physical operations;

FIG. 4 is another flow chart of exemplary operations relating to selecting a resource to perform physical operations;

FIG. 5 is a block diagram indicating how costs are determined for resource operations within the system;

FIG. 6 is a block diagram representing resource objects that can be used within a computer system;

FIG. 7 is a block diagram that describes the detailed interface model and dependencies for the resource object;

FIG. 8 is an execution flow diagram showing the layered invocation order within the computer system for initiating a resource; and

FIG. 9 is a block diagram of a general computer system.

Like reference numerals in the various drawings indicate like elements.

### DETAILED DESCRIPTION

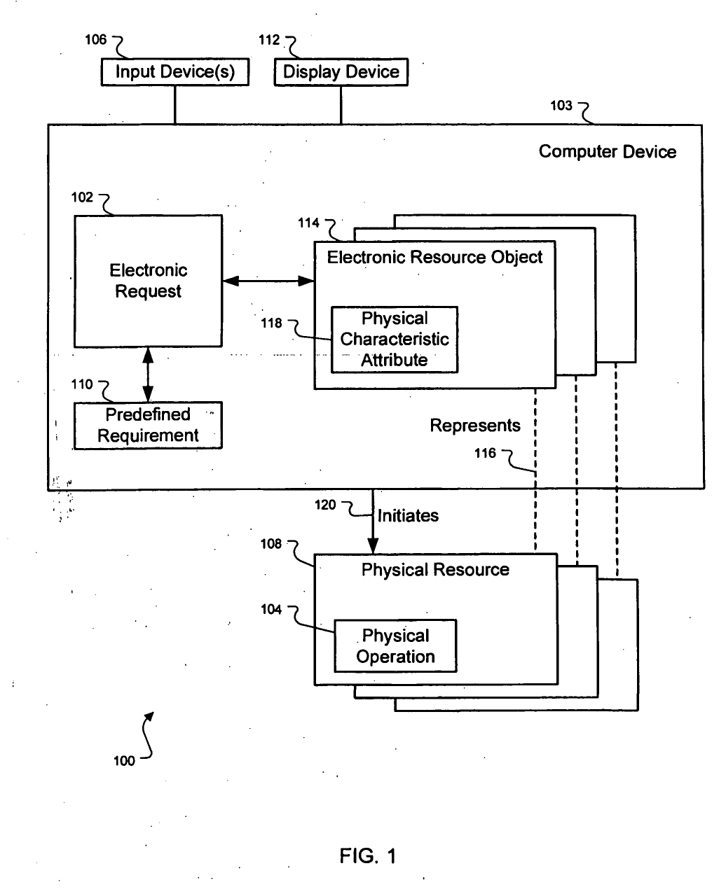

FIG. 1 shows a computer system 100 that automatically selects a physical resource to perform a physical operation. The computer system receives an electronic request identifying a physical operation to be performed. The electronic request may be initiated by a user input. The computer system identifies the physical operation as requiring use of a specific type of physical resource. The system includes one or more electronic resource objects that correspond to individual physical resources. Each electronic resource object includes an attribute representing a physical characteristic of the corresponding resource. There is a predefined requirement associated with performing the physical operation. The system determines whether the physical characteristic attribute of any of the electronic resource objects meets the predefined requirement. If so, the system uses that electronic resource object to cause the corresponding physical resource to perform the physical operation.

An electronic request 102 instructs the computer device 103 that a specific physical operation 104 is to be performed. For example, the electronic request 102 may represent a request to manufacture, move or store a product, the request being generated upon receiving a sales order. The electronic request 102 may be initiated by a user via input device(s) 106. The system 100 determines the specific type of physical resource 108 needed to complete the physical operation 104.

A predefined requirement 110 is associated with performing the physical operation 104. For example, the predefined requirement 110 may define the size or capacity of the machinery required to accomplish a specific task, or the minimum qualifications required of a person to operate the machinery, to name a few examples.

In some implementations, the system 100 generates the electronic request 102 upon the user entering information that indicates a sales order has been received. In other implementations, the user may directly input the electronic request 102 using the input device(s) 106. In yet other implementations, the electronic request 102 may be automatically generated upon the occurrence of a predefined event.

A display device 112 provides a user with resource and status information generated by the computer device 103. The information may include a list of physical operations that need to be performed, an interface for submitting electronic requests 102 or other tasks, identification of the physical resource 108 selected by the computer system, or messages that no resources are available, to name a few examples. The display device 112 may be used in conjunction with the input device(s) 106 to provide a user interface to the system 100.

Each of the electronic resource objects 114 corresponds to one of the physical resources 108 as indicated by lines 116. A physical characteristic attribute 118 is included in one or more of the electronic resource objects 114. The physical characteristic attribute 118 defines one or more physical characteristics of the physical resource 108. Examples of physical characteristics include one or more dimensions or capacities of the machinery, the size of products it can create or use, or the time required to complete the task. The system 100 compares any or all of the physical characteristic attributes 118 with the predefined requirement 110 to determine whether the physical characteristic attribute 118 meets the predefined requirement 110. If so, the system selects that electronic resource object 114 for the performance of the physical operation 104.

The system 100 may use the electronic resource object 114 in causing the corresponding physical resource 108 to perform the physical operation 104, as indicated by arrow 120. For example, when the physical resource 108 is an automated machine that the system 100 controls, the electronic resource object 114 can be used in directly controlling the physical resource 108 to perform the physical operation 104. As another example, when the physical resource 108 is to be operated by a person, the electronic resource object 114 can be used in formatting a message that instructs the person to perform the physical operation 104 using the physical resource 108.

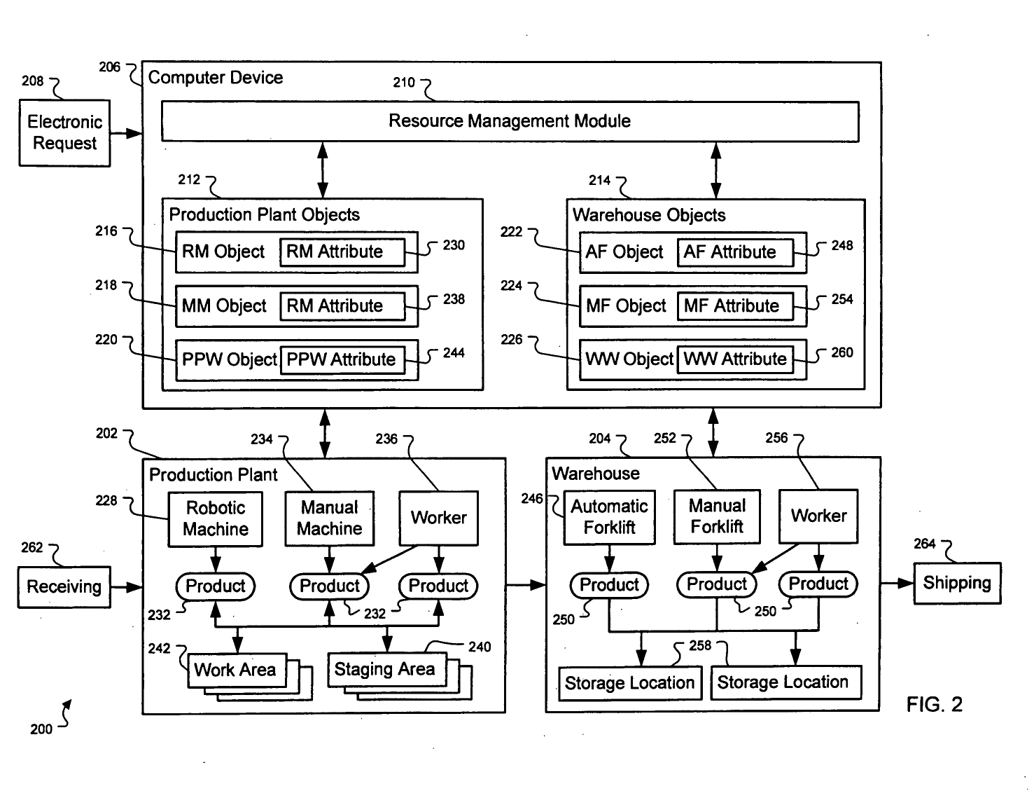

FIG. 2 shows another example involving automatically selecting physical resources to perform physical operations, here in a computer system 200. Resources are available within a production plant 202 and in a warehouse 204. A computer device 206 manages the activities in both locations. From time to time, the computer device 206 receives an electronic request 208 identifying a physical operation to be performed. This may be an operation for the production plant 202 or for the warehouse 204. A resource management module 210 identifies the physical operation as requiring use of a specific type of the available physical resources. The system includes one or more production plant objects 212 that represent individual physical resources within the production plant 202. Similarly, the system includes one or more warehouse objects 214 that represent individual physical resources within a warehouse 204. Depending on the requested physical operation, one or more of the production plant objects 212 or warehouse objects 214 may be selected. Production plant objects 212 comprise objects for various resource types such as robotic machine objects 216, manual machine objects 218 and production plant worker objects 220. Similarly, warehouse objects 214 comprise objects for various resource types such as automatic forklift objects 222, manual forklift objects 224 and warehouse worker objects 226.

Each robotic machine object 216 corresponds to an individual physical robotic machine 228 in the production plant 202. The robotic machine 228 may be a robotic drill press, an automatic conveyor belt, or a robotic paint sprayer, to name a few examples. A robotic machine attribute 230 is included in the robotic machine object 216. The robotic machine attribute 230 defines at least one physical characteristic of the robotic machine 228. Physical characteristics may include one or more dimensions or capacities of the robotic machine 228, the size of products 232 it can use or produce, or the time required to complete a specific task. For example, the robotic machine attribute 230 may indicate that its corresponding physical robotic machine 228 is capable of drilling a three-inch hole at a rate of four centimeters per hour.

Each manual machine object 218 corresponds to an individual physical manual machine 234 in the production plant 202. The manual machine 234 may be a manual drill, a riveting tool, or a welding machine, to name a few examples. Another example of a manual machine 234 is a lifting device, operated by a trained production plant worker 236, capable of moving a jet fighter wing from a staging area 240 to a work area 242. A manual machine attribute 238 is included in the manual machine object 218. The manual machine attribute 238 defines at least one physical characteristic of the manual machine 234. Physical characteristics may include one or more dimensions or capacities of the manual machine 234, the minimum qualifications of the person needed to operate the machinery, the size of products it can create or use, or the time required to complete a task. For example, the manual machine attribute 238 may indicate that its corresponding physical manual machine 234 is capable of moving airplane parts weighing up to 500 pounds in three minutes.

Each production plant worker object 220 corresponds to an individual physical worker 236 in the production plant 202. For example, the production plant worker 236 may be a machine operator, an electrician, or a foreman. A production plant worker attribute 244 is included in the production plant worker object 220. The production plant worker attribute 244 defines at least one physical characteristic of the production plant worker 236. Physical characteristics may indicate the operational capabilities and restrictions of the production plant worker 236. For example, the production plant worker attribute 244 may indicate that its corresponding physical production plant worker 236 is authorized to install electrical cables, operate selected manual machines 234, occupy a limited set of work areas 242, and lift no more than 50 pounds.

Each automatic forklift object 222 corresponds to an individual physical automatic forklift 246 in the warehouse 204. The automatic forklift 246 may move pallets, stack boxes, or load shipping containers, to name a few examples. An automatic forklift attribute 248 is included in the automatic forklift object 222. The automatic forklift attribute 248 defines at least one physical characteristic of the automatic forklift 246. Physical characteristics may include one or more dimensions or capacities of the automatic forklift 246, the size of products 250 it can use or moving, or the time required to complete a task. For example, the automatic forklift attribute 248 may indicate that its corresponding physical automatic forklift 246 is capable of retrieving a 500-pound pallet as high as 20 feet from any storage location 258 and moving it to a new storage location 258 in one minute.

Each manual forklift object 224 corresponds to an individual physical manual forklift 252 in the warehouse 204. The manual forklift 252 may be a stationary manned forklift, a mobile manned forklift, or a special forklift used for fragile loads, to name a few examples. A manual forklift attribute 254 is included in the manual forklift object 224. The manual forklift attribute 254 defines at least one physical characteristic of the manual forklift 252. Physical characteristics may include one or more dimensions or capacities of the manual forklift 252, the minimum qualifications of the person needed to operate the forklift, the size of pallets it can move, or the time required to complete a task. For example, the manual forklift attribute 254 may indicate that its corresponding physical manual forklift 252 is six feet wide and can be operated by any trained warehouse worker 256 to move up to 500-pound products 250 to any warehouse storage location 258.

Each warehouse worker object 226 corresponds to an individual physical worker 256 in the warehouse 204. For example, the warehouse worker 256 may be a stationary forklift operator, a mobile forklift operator, or a foreman. A warehouse worker attribute 260 is included in the warehouse worker object 226. The warehouse worker attribute 260 defines at least one physical characteristic of the warehouse worker 256. Physical characteristics may indicate the operational capabilities and restrictions of the warehouse worker 256. For example, the warehouse worker attribute 260 may indicate that its corresponding physical warehouse worker 256 is authorized to use 6-foot mobile forklifts, move products 250 to and from selected storage locations 258, and lift no more than 50 pounds.

The production plant 202 may obtain supplies from receiving 262. Examples of supplies may include raw materials for manufacturing products 232, component parts for assembling other products 232, or machinery needed in the production process. One or more robotic machines 228, manual machines 234, and production plant workers 236 may perform the operations to move the materials from receiving 262 into the production plant 202. Similarly, robotic machines 228, manual machines 234, and production plant workers 236 may move finished goods from the production plant 202 to the warehouse 204.

In the warehouse 204, automatic forklifts 246, manual forklifts 252, and warehouse workers 256 may move products 250 received from the production plant to storage locations 258. Similarly, the same warehouse 204 resources may move products 250 from storage locations 258 within the warehouse 204 to shipping 264.

In one implementation, a sales order for one or more electric toaster products 250 is received by the system 200. In attempting to fill the order, the system 200 may determine that the warehouse 204 contains insufficient inventory quantities of the electric toaster products 250 to complete the order. The system 200 may conclude that the electric toaster products 232 need to be manufactured in the production plant 202 to meet the sales order. While planning the production of products 232, the system 200 may determine that the production plant 202 contains insufficient supplies of raw materials to produce electric toaster products 232 not already stored in the warehouse 204. In order to start production of the products 232, the computer device 206 receives an electronic request 208 for an operation to move raw materials from receiving 262 into the production plant 202. For example, the request may be triggered upon a user authorizing the production of toasters.

The raw materials needed may be wire coils used in making heating elements in the electric toasters 232. The resource management module 210 selects one or more production plant objects 212 representing resources that are capable of performing the operations to move the wire coils into staging areas 240. The resource management module 210 may initiate or schedule the corresponding production plant resource to perform the operation. Actual production of the electric toaster products 232 may then begin.

The production process may be triggered by the same electronic request 208 as the operation of moving the raw materials, or a different one. The resource management module 210 again selects from available production plant objects 212. The resource management module 210 also continues to initiate or schedule the corresponding resources to perform the operations. For example, the resource management module 210 may initiate or schedule production plant workers 236 using manual machines 234 to weld wire coils into the electric toaster products 232. In another example, the resource management module 210 may initiate or schedule robotic machines 228 to move electric toaster products 232 in various stages of completion from work areas 242 to staging areas 240. The choice between manual or automatic may be made using the physical characteristics attributes. Eventually, the production plant 202 finishes enough electric toaster products 232 required to meet the sales. The resource management module 210 may then initiate or schedule production plant resources to move the finished electric toaster products 232 from the production plant 202 to the warehouse 204. Similarly here, the choice of resource may be made using the attributes.

The resource management module 210 also controls the movement of products 250 within the warehouse 204. In continuing to meet the sales order, the resource management module 210 may initiate or schedule an automatic forklift to move pallets containing finished electric toaster products 250 to storage locations 258 until they can be shipped. Similarly, to complete the sales order, the resource management module 210 may initiate or schedule manual forklifts 252 and warehouse workers 256 to move electric toaster products 250 from storage locations 258 into shipping containers for shipping 264. Similarly here, the choice of resource may be made using the attributes.

The resource selection in the system 200 may be done based on the predefined requirement 110. The predefined requirement 110, in turn, may depend on some other feature in the system. For example, when selecting a forklift for loading goods onto a truck, which is another resource, the selection of the forklift object may take into account the specific truck bed height for the particular truck. As another example, the selection of a forklift may take into account the physical dimensions of the storage location into which the goods should be moved. Thus, the predefined requirement 110 may relate to physical characteristics recorded for other objects within the system.

An advantage of the computer device 206 is that it permits the customer to customize object attributes, or add new ones, to fit the customer's particular implementation. For example, the customer can change the types of attributes and the number of attributes defined per object. The customer may define several user-defined attributes per object to represent physical capabilities or capacities of the corresponding resources. One benefit of defining additional attributes for objects is that the resource management module 210 may have more detailed information from which to make decisions during object selection. With more information available from object attributes, the resource management module 210 may be more likely to select an object corresponding to an available resource that is more suitable to perform the requested operation. The resource management module 210 may be configured with user-changeable features to provide for this customer-specific modification. For example, the resource management module 210 can provide an editing module in which the customer can add new objects having the desired attributes, or edit the preexisting objects.

The attributes may be refined in response to physical changes throughout the production plant 202 and warehouse 204. For example, the complete set of robotic drills initially may have similar attributes. Over time, the customer may add several user-defined attributes that further differentiate among the robotic drills. These attributes may identify factors such as resource speed, precision of its operations, or the cost to perform its operations. For example, when a resource is needed to drill a hole during production, the resource management module 210 may be more likely to select a resource that can drill the hole faster, more precisely, or at less cost.

Another advantage of the computer device 206 is that it permits dynamic changes to object attributes. Dynamic changes to attributes may be done automatically to represent real-time conditions of resources within the production plant 202 or the warehouse 204. For example, in the production plant 202, an attribute for an oven resource may dynamically track the oven's temperature. For example, the resource management module 210 is configured to poll the resources 228 or 234 through a suitable interface to determine a real-time physical characteristic. The resource management module 210 then updates the corresponding one of the attributes with the determined value. This real-time oven temperature information may allow the resource management module 210 to select an available oven resource whose current temperature matches the physical requirement of the operation to be performed. Other examples of dynamically changing attributes within the production plant 202 may include the color of paint currently loaded in a paint sprayer resource, or the current potential capacity of available resources within the production plant 202. Dynamic changes to attributes may also exist for warehouse resources. For example, an attribute for a storage location 258 may represent its current unused storage capacity. In another example, at attribute may track the current shipping capability of the warehouse 204 based on available automatic forklifts 246 and manual forklifts 252 not already in use. The warehouse shipping capability attribute may be one of several warehouse-level attributes representing whole classes of resource types.

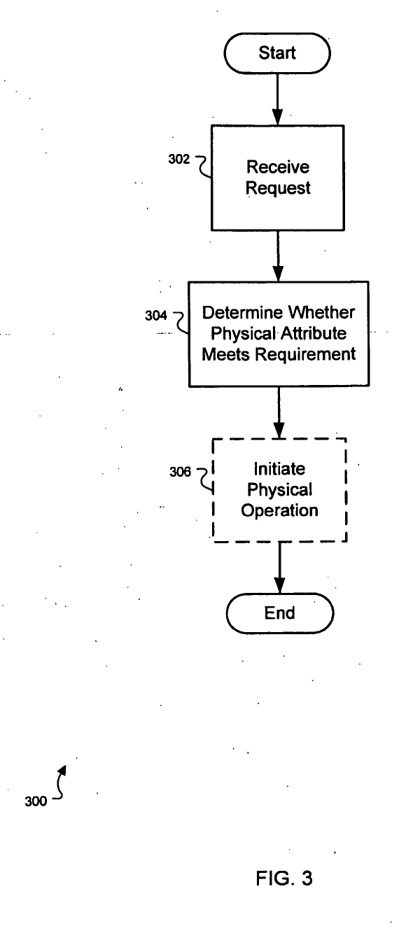

FIG. 3 is a flow chart of exemplary operations 300 relating to selecting resources to perform physical operations. For example, the operations 300 can be performed in the computer system 100. A processor executing instructions stored in a computer program product can perform the operations 300. The operations 300 begin in step 302 with receiving an electronic request to initiate performance of a physical operation. The physical operation is identified in the computer system as requiring the use of a specific type of physical resource. For example, referring to FIG. 1, the electronic request 102 is received in the computer device 103. Similarly, referring to FIG. 2, the electronic request 208 is received in the computer device 206. The electronic request may be initiated by a user typing in the request, or the electronic request may be automatically generated by the system, to name a few examples. The physical operation may be performable by a robotic machine 228, a manual machine 234, or a production plant worker 236, to name a few examples.

In step 304, it is determined whether at least one electronic resource object includes a physical characteristic attribute that meets the predefined requirement. The determination is made among at least one electronic resource object representing an individual physical resource having the specific type. For example, the system 100 identifies a predefined requirement 110 corresponding to the electronic request 102. The system 100 determines if any or all of the physical characteristic attributes 118 meet the predefined requirement 110. If so, the system selects that electronic resource object 114 for the performance of the physical operation 104. In another example, the resource management module 210 selects a production plant object 212 having an attribute that meets the predefined requirement associated with electronic request 208.

In optional step 306, performance of the physical operation is initiated. For example, if the electronic request 208 specifies that a robotic machine is to perform a specified operation, and the resource management module 210 selects a robotic machine object 216 meeting the corresponding predefined requirement, then the corresponding robotic machine 228 is initiated to perform the specified physical operation. If no suitable resource object is found, the step 306 may be omitted and a suitable output may be generated to notify a user of this situation.

The following is a brief example based on the operations 300 described above. A user inputs a sales order for fifty bags of concrete. The computer system receives a corresponding electronic request 208 for an automatic forklift to move a pallet of concrete product 250 storage location 258 to shipping 264. The resource management module 210 selects an automatic forklift object 222 having an automatic forklift attribute 248 that meets the predefined requirement of the electronic request 208. The computer system initiates the automatic forklift 248 to move the pallet of concrete product 250 storage location 258 to shipping 264.

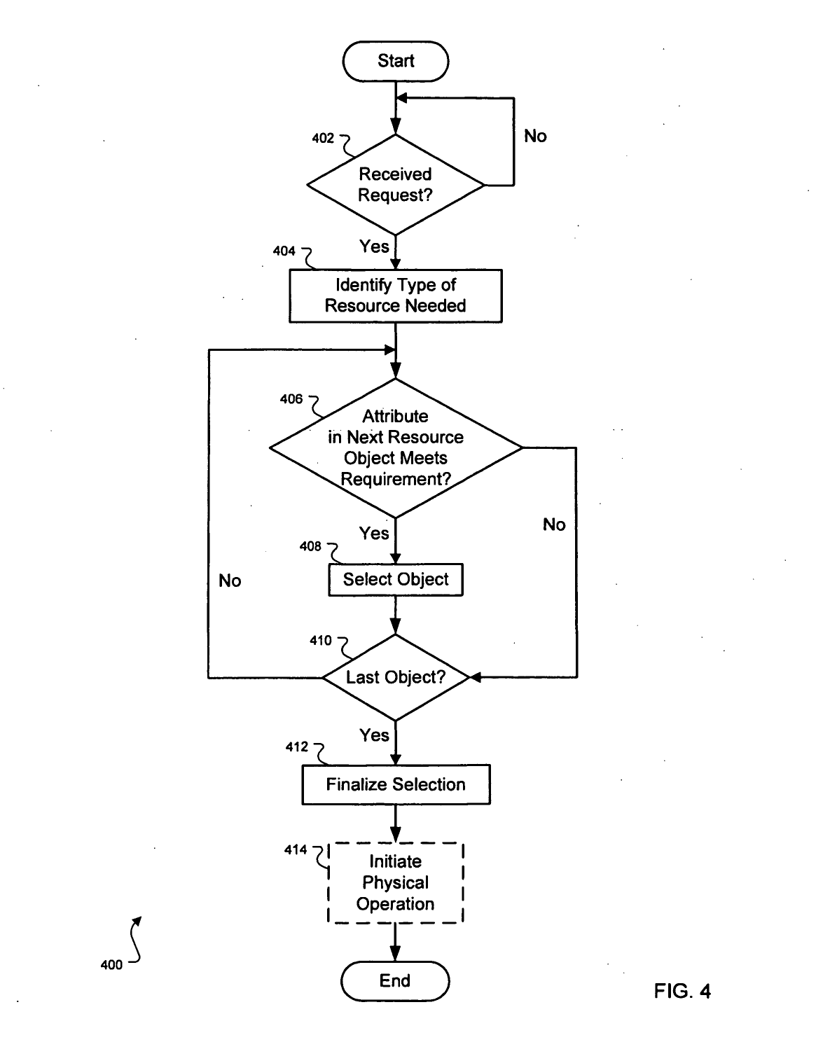

FIG. 4 is a flow chart of exemplary operations 400 relating to selecting resources to perform physical operations. For example, the operations 400 can be performed in the computer system 100. A processor executing instructions stored in a computer program product can perform the operations 400. The operations 400 begin in step 402 which is a polling loop for receiving an electronic request to initiate performance of a physical operation. The loop repeats until an electronic request is received. For example, referring to FIG. 2, the computer device 206 waits for an electronic request 208 to be received. The electronic request may be initiated by a user typing in the request, or the electronic request may be automatically generated by the system, to name a few examples.

In step 404, the specific type of physical needed for the physical operation is identified in the computer system. The physical operation, having been defined by the electronic request received, may be performable by a robotic machine 228, a manual machine 234, or a production plant worker 236, to name a few examples.

In step 406, it is determined whether at least one electronic resource object includes a physical characteristic attribute that meets the predefined requirement. The determination is made one resource object at a time from among at least one electronic resource object representing an individual physical resource having the specific type. For example, referring to FIG. 1, the system 100 identifies a predefined requirement 110 corresponding to the electronic request 102. The system 100 determines if any or all of the physical characteristic attributes 118 meet the predefined requirement 110. If so, the resource object can be selected; otherwise, the next resource object can be examined.

If the answer in step 406 is yes, the resource object is selected in step 408. For example, for a robotic machine 228 to be selected in this step, it must be the specified resource type and be capable of performing the specified operation. The selection in step 408 may be preliminary, as will be described below.

Step 410 involves a loop that cycles through the resource objects during the selection process. If the last resource object has been examined, the loop can be exited. Otherwise, the loop repeats, allowing the next resource object to be examined. The loop may be exited if sufficient resource objects have already been selected.

Step 412 finalizes the selection process. For example, if no resource object is found, a suitable output may be generated to notify a user of this situation. In such a situation, step 414 may be omitted. In another example, if more resource objects are found than are needed, redundant resource objects may be discarded in step 412 using a predefined rule.

In optional step 414, performance of the physical operation is initiated. For example, if the electronic request 208 specifies that a robotic machine is to perform a specified operation, and the resource management module 210 selects a robotic machine object 216 meeting the corresponding predefined requirement, then the corresponding robotic machine 228 is initiated to perform the specified physical operation. In another example, if the electronic request 208 specifies that a manual operation is to be performed in the warehouse 204, the resource management module 210 sends an electronic message to the warehouse worker 256, instructing the worker to perform the operation.

The following is a brief example based on the operations 400 described above. A user inputs a sales order for fifty bags of concrete. The computer system loops until it receives the corresponding electronic request 208 to move a pallet of concrete product 250 storage location 258 to shipping 264. The system identifies the type of resource needed to move the pallet as an automatic forklift 246. The resource management module 210 enters a loop to examine individually each resource object. The resource management module 210 selects any automatic forklift object 222 having an automatic forklift attribute 248 that meets the predefined requirement. This selection step may be interrupted when a sufficient amount or number of resources has been identified. Alternatively, all qualified resources can first be identified and thereafter narrowed down to the required number. The computer system initiates the automatic forklift 248 to move the pallet of concrete product 250 from storage location 258 to shipping 264.

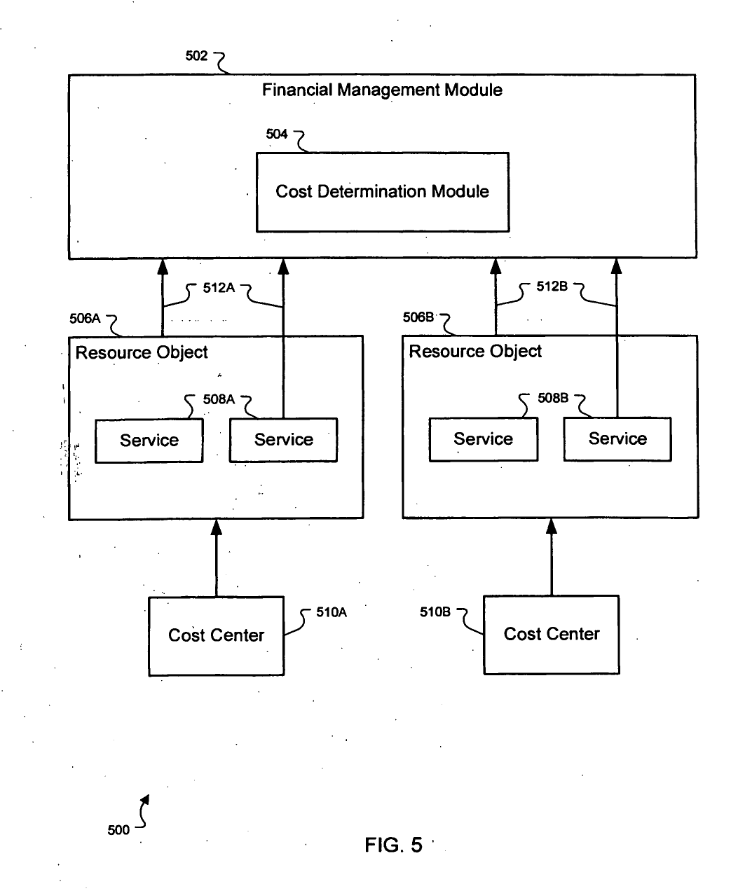

FIG. 5 shows components 500 used in determining costs for resource operations within a system. A financial management module 502 performs financial resource functions within the system, including financial planning, cost control, and cost calculations, to name a few examples. A cost determination module 504 performs the cost calculations function for the system. The calculations may provide the system with costs and expenses for billing functions after the operations are complete.

The cost determination module 504 uses cost information defined for resource objects 506 A and B defined within the system. Each resource object 506 represents a corresponding physical resource within the organization. Each resource 506 object is associated with one or more services 508 A and B corresponding to the operations that a resource 506 can perform. Each resource 506 is also associated with a cost center 510. The cost centers 510 may be part of organizational centers in the system.

To calculate the cost of an operation performed by a resource, the cost determination module 504 may use any combination of inputs. The cost determination module 504 may base the cost solely on resource information, on service information, or both, as indicated by arrows 512. For example, resource 506A may be a drill capable of performing only one service: drilling 508A. The cost may be based on the identity of the resource 506A. In another example, resource 506A may be a machine with a drilling service and a routing service. In this case, the cost may be based on the performed service. In yet another example, the services provided by the resources 506 A and B may be identical, but the services performed by the resource 508B are more expensive than the services performed by the resource 508A. In this case, cost may be based both on resource and service.

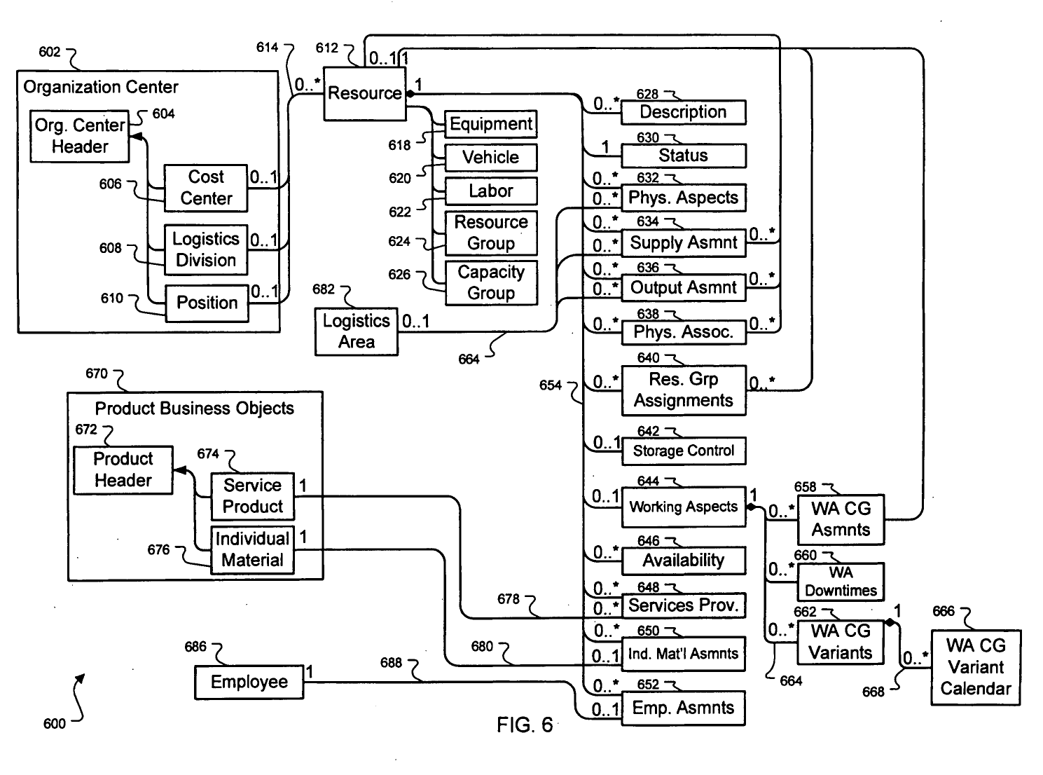

FIG. 6 is a diagram 600 representing resource objects that can be used within a computer system. The organization center 602 represents an entity within the system that can have resources associated with it. The organization center 602 comprises an organizational center header 604, a cost center node 606, a logistics division node 608, and a position node 610. Each component of the organization center 602 is associated with zero or more resource objects 612 as indicated by lines and cardinalities 614. Similarly, each resource 612 is associated with zero or one of the nodes 606, 608 and 610. The resource 612 may be of any resource type, including an equipment resource 618, a vehicle resource 620, a labor resource 622, a resource group 624, or a capacity group 626, to name a few examples. Each resource 612 may be represented by several characteristics including, but not limited to, a description 628, a status 630, physical aspects 632, supply area assignments 634, output area assignments 636, physical associations 638, resource group assignments 640, storage control 642, working aspects 644, availability 646, services provided 648, individual material assignment 650, and employee assignments 652. Lines and cardinalities 654 indicate one implementation of the number of each characteristic a specific resource may have. The working aspects 644 characteristic may be further defined by working aspect capacity group assignments 658, working aspect downtimes 660, and working aspect working capacity variants 662. Lines and cardinalities 664 indicate that each working aspect 644 may comprise zero or more capacity group assignments 658, working aspect downtimes 660, and working aspect working capacity variants 662. However, each one of the capacity group assignments 658, working aspect downtimes 660, and working aspect working capacity variants 662 defines a unique working aspect 644. Each specific working aspect working capacity variant 662 may be further defined by zero or more working aspect working capacity variant calendars 666 as indicated by lines and cardinalities 668.

The computer system also includes a group of product business objects 670. The product business objects 670 comprise product headers 672, service product nodes 674, and individual material nodes 676. Each service product node 674 is defined by zero or more services provided 648 characteristics, as indicated by lines and cardinalities 678. Each individual material node 676 is further defined by zero or one individual material assignment 650 characteristic, as indicated by lines and cardinalities 680.

The computer system also includes a logistics area 682 business object which is uniquely defined by zero or more physical aspects 632, supply area assignments 634, and output area assignments 636, as indicated by lines and cardinalities 684. The computer system further includes an employee 686 business object which is uniquely defined by zero or one employee assignments 652, as indicated by lines and cardinalities 688.

The diagram 600 shows that each resource object can have the physical aspects node 632. This node is used in associating one or more physical characteristics attributes with the resource object. The physical characteristics attribute(s) can be used in deciding whether to select the resource represented by the object for a specific physical operation. Different attributes and selection processes may be used for resources of different types, such as for vehicles and employees. The resource object attributes can be configured by the customer of the system to fit the particular physical resources used on the customer's premises. Also, values for the physical characteristics attribute(s) can be dynamically assigned essentially in real time during operation to provide for resource selection that takes into account fluctuating or frequently changing physical characteristics.

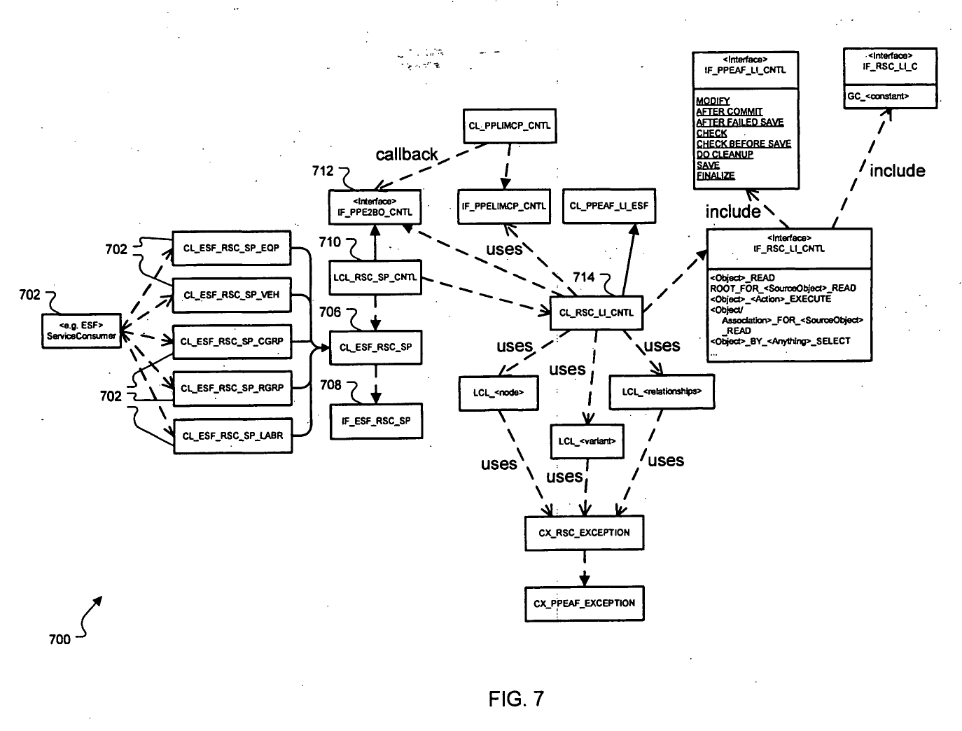

FIG. 7 is a relationship diagram 700 that describes a detailed interface model and dependencies for use with a resource object. Production plant and warehouse operation requests are handled via a service consumer 702. To initiate an operation, the service consumer 702 invokes a service provider 704 representing categories of service providers such as equipment, vehicles, cost group, resource group and labor. A single resource service provider 706 handles the service provider needs of the individual service provider categories 704. The resource service provider 706 uses a service provider class 708 as the interface to the resource. The resource service provider 706 delegates the request to an implementation class 710. The implementation class 710 uses a business object interface 712 to map business object entities to an integrated product and process engineering module and vice versa. The implementation class 710 also uses an implementation class 714 to execute the application specific logic for the resource operation. As shown in the diagram above there are five service providers for the projections and one service provider for a template object. The projection service providers delegate the service requests to the template service provider. The template service provider is a “superset” provider which implements the logic that is relevant for all of the projections.

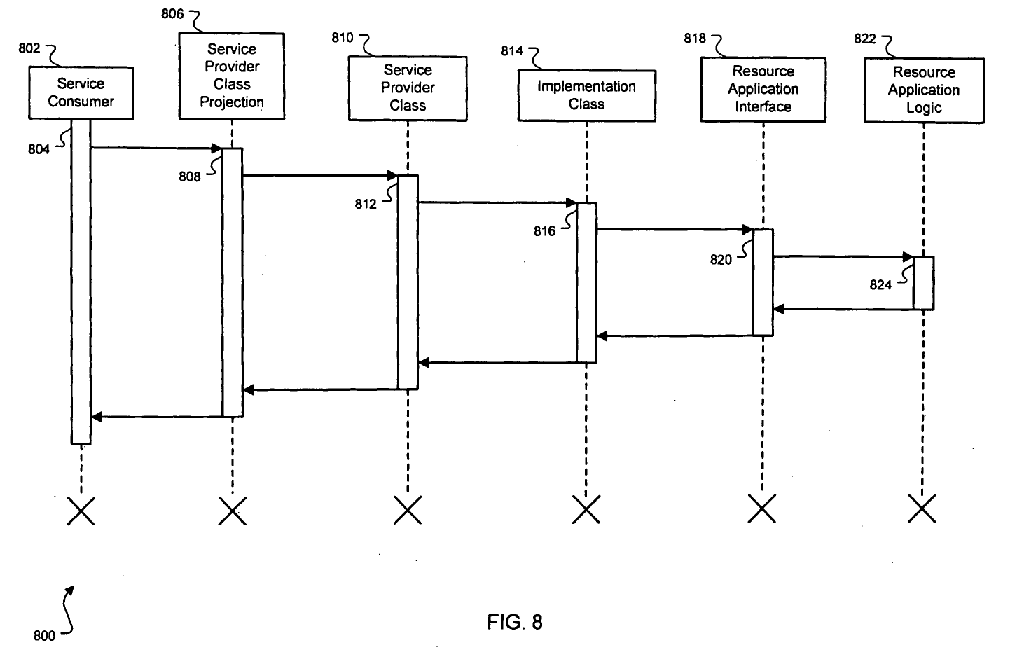

FIG. 8 is an execution flow diagram 800 showing a layered invocation order within a computer system for initiating a resource. The computer system invokes the service consumer 802 to initiate a resource to perform an operation. This indicates a need for the resource in the system. Bar 804 indicates the duration that the service consumer 802 is active. The service consumer 802 delegates the request handling to the service provider class projection 806 whose duration is indicated by bar 808. The projection is selected based on the requested type of resource; for example, a piece of equipment, a vehicle or an individual (laborer) may be needed. The service provider class projection 806 invokes the service provider class 810 whose duration is indicated by bar 812. This is the service provider for objects of the type resource. The service provider class 810 delegates the request to the implementation class 814 whose duration is indicated by bar 816. This class implements an interface that enables an application to define application-specific transformations involving the resource object. The implementation class 814 invokes the resource application interface 818 whose duration is indicated by bar 820. This interface contains all public methods of the application layer that have application-specific semantics. The resource application interface 818 initiates the resource application logic 822 which has a duration indicated by bar 824. Control is passed from the resource application logic 822 sequentially back to the service consumer 802. This allows the system to identify the proper resource and initiate the physical operation.

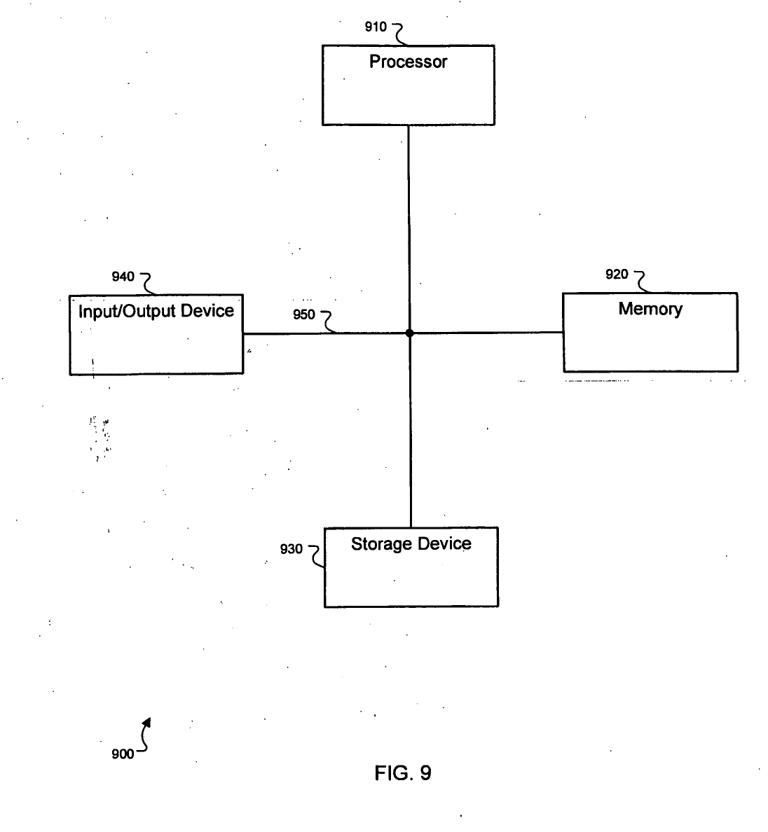

FIG. 9 is a block diagram of a computer system 900 that can be used in the operations described above, according to one embodiment. For example, the system 900 may be included in either or all of the computer system 100 and the computer system 200.

The system 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one embodiment, the processor 910 is a single-threaded processor. In another embodiment, the processor 910 is a multi-threaded processor. The processor 910 is capable of processing instructions stored in the memory 920 or on the storage device 930 to display graphical information for a user interface on the input/output device 940.

The memory 920 stores information within the system 900. In one embodiment, the memory 920 is a computer-readable medium. In one embodiment, the memory 920 is a volatile memory unit. In another embodiment, the memory 920 is a non-volatile memory unit.

The storage device 930 is capable of providing mass storage for the system 900. In one embodiment, the storage device 930 is a computer-readable medium. In various different embodiments, the storage device 930 may be a floppy disk device, a hard disk device, an optical disk device, or a tape device.

The input/output device 940 provides input/output operations for the system 900. In one embodiment, the input/output device 940 includes a keyboard and/or pointing device. In one embodiment, the input/output device 940 includes a display unit for displaying graphical user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method of selecting resources to perform physical operations, the method comprising:
receiving, in a computer system, an electronic request to initiate performance of a physical operation, the physical operation being identified in the computer system as requiring use of a specific type of physical resource; and
determining, among at least one electronic resource object representing an individual physical resource having the specific type, whether the at least one electronic resource object includes a physical characteristic attribute that meets a predefined requirement associated with performing the physical operation.

2. The method of claim 1, wherein the electronic resource object has the physical characteristic attribute that meets the predefined requirement, further comprising selecting the physical resource represented by the electronic resource object and initiating performance of the physical operation.

3. The method of claim 2, further comprising determining associated costs after the performance of the physical operation using the electronic resource object.

4. The method of claim 1, further comprising obtaining the predefined requirement from another resource object that is to be involved in performance of the physical operation.

5. The method of claim 1, further comprising obtaining the predefined requirement from a storage location that is to be involved in performance of the physical operation.

6. The method of claim 1, wherein the computer system includes several electronic resource objects, wherein at least one of the several electronic resource objects corresponds to a production plant resource and at least one of the several electronic resource objects corresponds to a warehouse resource.

7. The method of claim 6, wherein the several electronic resource objects are configured so that the determination step can be performed for operations involving the production plant resource and for operations involving the warehouse resource.

8. The method of claim 1, further comprising automatically updating the physical characteristic attribute based on a change in the physical resource.

9. A computer program product tangibly embodied in an information carrier, the computer program product including instructions that, when executed, cause a processor to perform operations comprising:
receiving, in a computer system, an electronic request to initiate performance of a physical operation, the physical operation being identified in the computer system as requiring use of a specific type of physical resource; and
determining, among at least one electronic resource object representing an individual physical resource having the specific type, whether the at least one electronic resource object includes a physical characteristic attribute that meets a predefined requirement associated with performing the physical operation.

10. A computer system comprising:
a repository having stored therein resource objects corresponding to respective physical resources of particular types, the system being configured to use any of the resource objects in initiating performance of a physical operation using the corresponding physical resource; and
a resource management module configured to determine whether any of the resource objects that is of a specific type needed for a physical operation includes a physical characteristic attribute that meets a predefined requirement associated with performing the physical operation.

11. The computer system of claim 10, wherein the resource management module is configured to select the physical resource represented by the resource object upon determining that the resource object has the physical characteristic attribute that meets the predefined requirement and initiate performance of the physical operation.

12. The computer system of claim 10, further comprising a cost determination module configured to determine associated costs after the performance of the physical operation using the resource object.

13. The computer system of claim 10, wherein the resource management module is configured to obtain the predefined requirement from another resource object that is to be involved in performance of the physical operation.

14. The computer system of claim 10, wherein the resource management module is configured to obtain the predefined requirement from a storage location that is to be involved in performance of the physical operation.

15. The computer system of claim 10, wherein at least one of the several resource objects corresponds to a production plant resource and at least one of the several electronic resource objects corresponds to a warehouse resource.

16. The computer system of claim 15, wherein the several resource objects are configured so that the resource management module can perform the determination for operations involving the production plant resource and for operations involving the warehouse resource.

17. The computer system of claim 10, wherein the resource management module is configured to automatically update the physical characteristic attribute based on a change in the physical resource.

18. The computer system of claim 10, wherein the resource management module is configured so that the physical characteristics attributes can be modified.
